(19) United States
(12) Patent Application Publication
(10) Pub. No.: US 2022/0253457 A1
(43) Pub. Date: Aug. 11, 2022

(54) Block Generation Control Method Applied to Blockchain and Related Apparatus

(71) Applicant: WEALEDGER NETWORK TECHNOLOGIES CO., LTD., Shenzhen (CN)

(72) Inventors: Wenbin Cheng, Shenzhen (CN); Mengbin Le, Shenzhen (CN)

(21) Appl. No.: 17/587,712

(22) Filed: Jan. 28, 2022

(30) Foreign Application Priority Data
Feb. 5, 2021 (CN) 202110161807.3

(51) Int. Cl. G06F 16/27; H04L 9/08; G06F 7/72

(52) U.S. Cl. CPC G06F 16/27; H04L 9/088; H04L 2209/463; H04L 2209/38; G06F 7/721

(57) ABSTRACT

The present application provides a block generation control method applied to a blockchain and a related apparatus, which relate to the technical field of blockchains. The block generation control method includes: triggering a current speaker node and a current deputy speaker node in the two or more congress member nodes to generate two candidate blocks, respectively; triggering all or part of nodes in the two or more congress member nodes to vote on the two candidate blocks generated, to generate a voting result; and determining, based on the voting result, one candidate block of the two candidate blocks that satisfies a preset vote number condition as a new block of the blockchain.

### CROSS-REFERENCE TO RELATED APPLICATIONS

This application claims priority to Chinese Patent Application No. 2021101618073, filed on Feb. 5, 2021, which is hereby incorporated herein by reference in its entirety.

### TECHNICAL FIELD

The present application relates to the technical field of blockchains, and in particular, to a block generation control method applied to a blockchain, and a related apparatus.

### BACKGROUND

Blockchain combines data blocks into a chain data structure in a timestamp order, and cryptographically ensures that this distributed ledger cannot be tampered with or forged. Essentially, it is a shared database. Data or information stored in the shared database has the characteristics of unforgeability, markability, traceability, openness and transparency, collective maintenance, and the like.

With the development of the era, a blockchain technology has received more and more attention. How to formulate a reasonable block generation control method (consensus mechanism) has become the focus of research in this art.

In the prior art, commonly used block generation control methods (consensus mechanism) in the blockchain include PoW (Proof of Work) consensus and PoS (Proof of Stake) consensus. A next block (such as the PoW consensus) is usually determined through node HashRate comparison, or a next block (such as the PoS consensus) is determined using asset rights and assets. The former will cause a potential hazard that large-HashRate nodes (mining pools/mining farms) control the right to generate blocks of the blockchain for a long time, and the latter will lead to a situation that assets owners (the PoS consensus believes that those with more assets will not do evil) continue to obtain benefits, which reduces the security of block generation.

HashRate is a unit of measurement of the processing capability of the blockchain, which is defined as a rate at which the computer calculates an output of a hash function. A mining farm is a collection of physical spaces where dozens, hundreds or even thousands of mining machines (servers) are centrally operated and managed; while a mining pool is a collection of virtual spaces where the computing capabilities of dozens, hundreds or even thousands of mining machines (servers) are systematically clustered.

There is also a practical byzantine fault tolerance (PBFT) consensus in the prior art, which can ensure the speed and security of block generation under certain conditions. However, roles and business logic are complex, and the fault tolerance rate is low (if there are more than ⅓ malicious nodes, the entire network cannot continue to run). This application intends to provide a new consensus mechanism to improve the fault tolerance rate, speed, and security of block generation.

### SUMMARY

These and other problems are generally solved or circumvented, and technical advantages are generally achieved, by embodiments of the present disclosure which provide a block generation control method applied to a blockchain, and a related apparatus.

### Technical Problems

The present application provides a block generation control method applied to a blockchain and a related apparatus, which can effectively improve the fault tolerant rate, speed and security of block generation.

### Technical Solutions

In order to achieve the above-mentioned technical effect, a first aspect of the present application provides a block generation control method applied to a blockchain. The blockchain includes two or more congress member nodes; the block generation control method includes a first triggering step, a second triggering step, and a determining step.

The first triggering step: triggering a current speaker node and a current deputy speaker node in the two or more congress member nodes to generate two candidate blocks, respectively. That is, each of the current speaker node and the current deputy speaker node is triggered to generate one candidate block, resulting in the two candidate blocks. The second triggering step: triggering all or part of nodes in the two or more congress member nodes to vote on the two candidate blocks generated, to generate a voting result; and the determining step: determining, based on the voting result, one candidate block of the two candidate blocks that satisfies a preset vote number condition as a new block of the blockchain.

Based on the first aspect of the present application, in a first possible implementation mode, the second triggering step includes: triggering each node in the two or more congress member nodes to vote an affirmative vote for the two candidate blocks generated, wherein each node in the two or more congress member nodes only votes the affirmative vote for one of the two candidate blocks generated; and the preset vote number condition includes: an obtained number of the affirmative vote in the voting result is greater than a preset number.

Based on the first possible implementation mode of the first aspect of the present application, in a second possible implementation mode, the preset number is greater than half of a number of the two or more congress member nodes; the determining step further includes: abandoning the other one of the two candidate blocks that does not satisfy the preset vote number condition.

Based on the first aspect of the present application or the first or the second possible implementation mode of the first aspect of the present application, in a third possible implementation mode, before the first triggering step, the block generation control method further includes a voting step.

The voting step: determining the current speaker node and the current deputy speaker node based on a preset polling mechanism, a current moment, and a generation complete moment of a previous block of the new block in the blockchain.

Based on the third possible implementation mode of the first aspect of the present application, in a fourth possible implementation mode, after the first triggering step, the block generation control method further includes: when a used duration reaches a preset duration threshold, performing the voting step, the first triggering step, the second triggering step and the determining step in sequence, wherein the used duration is a duration between the generation complete moment and the current moment.

Based on the fourth possible implementation mode of the first aspect of the present application, in a fifth possible implementation mode, each of the two or more congress member nodes has a sequence number, sequence numbers of the two or more congress member nodes being continuous and starting from zero, wherein the sequence number is an integer; the voting step includes a first voting step and a second voting step.

The first voting step: determining a deviation value based on the used duration and the preset duration threshold; and the second voting step: determining the current speaker node and the current deputy speaker node based on the deviation value and the sequence numbers of the two or more congress member nodes.

Based on the fifth possible implementation mode of the first aspect of the present application, in a sixth possible implementation mode, the first voting step includes: dividing the used duration by the preset duration threshold to obtain a quotient, and rounding down the quotient to obtain the deviation value.

And the second voting step includes: determining a height of the new block; dividing a sum of the height of the new block and the deviation value by the number of the two or more congress member nodes to obtain a first remainder; dividing a sum of the height of the new block, the deviation value, and one by the number of the two or more congress member nodes to obtain a second remainder; and determining, from the two or more congress member nodes, a first node having the sequence number equal to the first remainder as the current speaker node, and determining, from the two or more congress member nodes, a second node having the sequence number equal to the second remainder as the current deputy speaker node.

Based on the first aspect of the present application or the first or the second possible implementation mode of the first aspect of the present application, in a seventh possible implementation mode, the block generation control method further includes: when a target node exists in the two or more congress member nodes of the blockchain, determining the target node as a non-congress member node, wherein the target node is a node that fails to generate a candidate block for a preset number of consecutive times when the node is the current speaker node.

A second aspect of the present application provides a block generation control apparatus applied to a blockchain. The blockchain includes two or more congress member nodes. The block generation control apparatus includes a non-transitory memory and a processor. The memory stores a computer program. The processor executes the computer program to implement the steps of the block generation control method mentioned in the first aspect or any one possible implementation mode of the first aspect of the present application.

A third aspect of the present application provides a non-transitory computer-readable storage medium. The non-transitory computer-readable storage medium stores a computer program, wherein the computer program, when executed by a processor, implements the steps of the block generation control method mentioned in the first aspect or any one possible implementation mode of the first aspect of the present application

### Advantageous Effects of the Disclosure

It can be seen from the above that the technical solutions include triggering a current speaker node and a current deputy speaker node in the two or more congress member nodes to start to generate two candidate blocks, respectively; triggering all or part of nodes in the two or more congress member nodes to vote on the two candidate blocks generated, to generate a voting result; and determining, based on the voting result, one candidate block of the two candidate blocks generated that satisfies a preset vote number condition as a new block of the blockchain.

Based on the technical solutions of the present application, a situation that a malicious node generates a block can be avoided by means of voting (when the congress member nodes do not include more than half of malicious nodes, it can be ensured that blocks are normally generated). Votes can be taken on the two candidate blocks generated by the current speaker node and the current deputy speaker node, and the competitiveness of the generated blocks is ensured by means of determining the new block of the blockchain, so that the fault tolerance rate, speed and security of block generation are improved.

### BRIEF DESCRIPTION OF THE DRAWINGS

In order to describe the technical solutions in the embodiments of the present application more clearly, drawings required to be used in the embodiments or the illustration of the existing art will be briefly introduced below. Obviously, the drawings in the illustration below are only some embodiments of the present application. Those of ordinary skill in the art also can acquire other drawings according to the provided drawings without doing creative work.

FIG. 1 is a flowchart of a block generation control method applied to a blockchain provided by one embodiment of the present application;

FIG. 2 is a schematic structural diagram of a block generation control apparatus applied to a blockchain provided by one embodiment of the present application; and

FIG. 3 is a schematic structural diagram of a block generation control apparatus applied to a blockchain provided by another embodiment of the present application.

Corresponding numerals and symbols in the different figures generally refer to corresponding parts unless otherwise indicated. The figures are drawn to clearly illustrate the relevant aspects of the various embodiments and are not necessarily drawn to scale.

### DETAILED DESCRIPTION OF ILLUSTRATIVE EMBODIMENTS

In the following description, for the purpose of illustration rather than limitation, specific details such as specific system structures and technologies are proposed for a thorough understanding of the embodiments of the present application. However, it should be clear to those skilled in the art that the present application can also be implemented in other embodiments without these specific details. In other cases, detailed descriptions of well-known systems, devices, circuits, and methods are omitted to avoid unnecessary details from obstructing the description of the present application.

It should be understood that when used in this specification and the appended claims, the term “include” and “comprise” indicates the presence of the described feature, integer, step, operation, element and/or component, but does not exclude the presence or addition of one or more other features, integers, steps, operations, elements, components and/or a collection thereof.

It should also be understood that the terms used in the specification of the present application are for the purpose of describing particular embodiments only and are not intended to limit the present application. As used in this specification and the appended claims, the singular forms “a” “an” and “the” are intended to include the plural unless the context clearly dictates otherwise.

The technical solutions in the embodiments of the present application will be clearly and completely described below with reference to the drawings in the embodiments of the present application. Obviously, the described embodiments are only a part of the embodiments of the present application, rather than all the embodiments. Based on the embodiments in the present application, all other embodiments obtained by those of ordinary skill in the art without creative work shall fall within the protection scope of the present application.

Many specific details are set forth in the following description to facilitate a full understanding of the present application. However, the present application can also be implemented in other ways different from those described herein, and those skilled in the art can do so without departing from the connotation of the present application. Therefore, the present application is not limited by the specific embodiments disclosed below.

### Embodiment I

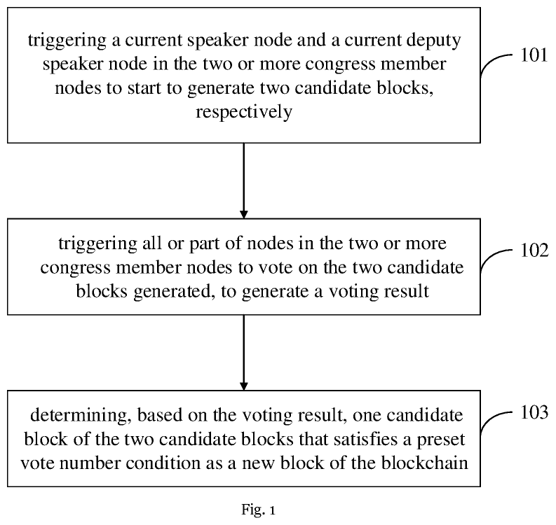

The present application provides a block generation control method applied to a blockchain. The blockchain includes two or more congress member nodes. As shown in FIG. 1, the block generation control method includes step 101, step 102, and step 103.

At step 101: triggering a current speaker node and a current deputy speaker node in the two or more congress member nodes to generate two candidate blocks, respectively. That is, step 101 triggers each of the current speaker node and the current deputy speaker node to generate one candidate block, resulting in generation of the two candidate blocks.

In this embodiment of the present application, in the two or more congress member nodes, there are two nodes which are respectively used as the current speaker node and the current deputy speaker node. The current speaker node and the current deputy speaker node have capabilities of generating candidate blocks. The candidate blocks generated need to go through the subsequent steps before they possibly become new blocks of the blockchain. The current speaker node and the current deputy speaker node in the two or more congress member nodes may be triggered on the basis of a smart contract to respectively start to generate one candidate block.

It can be understood that the current speaker node and the current deputy speaker node are two node representatives in the two or more congress member nodes and respectively generate one candidate block. In other words, the current speaker node can generate a first candidate block, and the current deputy speaker node also can generate a second candidate block, so there are two candidate blocks generated in total. The first candidate block and the second candidate block may or may not be the same.

At step 102: triggering all or part of nodes in the two or more congress member nodes to vote on the two candidate blocks generated, to generate a voting result.

In this embodiment of the present application, in step 101, when any one of the current speaker node and the current deputy speaker node generates one candidate block, all or part of the nodes in the two or more congress member nodes may be triggered to respectively vote the two candidate blocks generated. Each node may only vote an affirmative vote for one of the candidate blocks generated by the current speaker node and the current deputy speaker node and vote against the another candidate block other than the candidate block voted for, or does not vote on the another candidate block other than the candidate block voted for, so as to prevent a votes conflict.

At step 103: determining, based on the voting result, one candidate block of the two candidate blocks that satisfies a preset vote number condition as a new block of the blockchain.

In this embodiment of the present application, when one of the two candidate blocks generated satisfies the preset vote number condition, the one of the two candidate blocks generated that satisfies the preset vote number condition is determined as a new block of the blockchain to complete a process of generating blocks of the blockchain.

It can be understood that the blockchain is a decentralization system including nodes and blocks, wherein the nodes are used to generate blocks, and a plurality of blocks form a data chain. Blocks store input information, input information feature values, version numbers, timestamps, difficulty values, transaction (TX) list, TX-ID hash-tree, smart contract code, smart contract data, and so on.

Each node in the blockchain can be a server or a terminal device. The server can be an independent physical server, or a server cluster or distributed system composed of multiple physical servers, or it can provide cloud services, cloud databases, cloud computing, cloud functions, cloud storage, network services, cloud servers for cloud communications, middleware services, domain name services, security services, content delivery network, and/or basic cloud computing services such as big data and artificial intelligence platforms. The terminal device may be a smart phone, a tablet computer, a notebook computer, a desktop computer, a smart speaker, a smart watch, etc., but is not limited thereto. Each node may be directly or indirectly connected through wired or wireless connections, which is not limited in this application.

It can be seen from the above that the technical solutions include triggering a current speaker node and a current deputy speaker node in the two or more congress member nodes to start to generate two candidate blocks, respectively; triggering all or part of nodes in the two or more congress member nodes to vote on the two candidate blocks generated, to generate a voting result; and determining, based on the voting result, one candidate block of the two candidate blocks generated that satisfies a preset vote number condition as a new block of the blockchain.

Based on the technical solutions of the present application, a situation that a malicious node generates a block can be avoided by means of voting (when the congress member nodes do not include more than half of malicious nodes, it can be ensured that blocks are normally generated). Votes can be taken on the two candidate blocks generated by the current speaker node and the current deputy speaker node, and the competitiveness of the generated blocks is ensured by means of determining the new block of the blockchain, so that the fault tolerance rate, speed and security of block generation are improved.

In some implementation modes, step 102 includes: triggering each node in the two or more congress member nodes to vote an affirmative vote for the two candidate blocks generated. Each node in the two or more congress member nodes only votes the affirmative vote for one of the two candidate blocks generated. In other words, one node may vote an affirmative vote for one candidate block at most. The preset vote number condition include: a number of the affirmative vote obtained in the voting result is greater than a preset number.

One node may vote an affirmative vote for one candidate block at most, which can avoid such a phenomenon that part or all of the nodes vote the two candidate blocks generated, resulting in that the two candidate blocks generated obtain the same number of votes. At the same time, by means of setting the preset number in advance, the number of the affirmative vote can be determined more intuitively and clearly. Furthermore, the new block can be determined only when the number of the affirmative vote is greater than the preset number, which ensures the security and competitiveness of the new block.

Based on the above-mentioned preset vote number condition, in some implementation modes, the preset number is greater than half of the number of the two or more congress member nodes. Step 103 further includes: abandoning the other one of the two candidate blocks that does not satisfy the preset vote number condition.

Specifically, the preset number may be any number that is greater than half of the number of the two or more congress member nodes, which is not limited here. The preset number is not greater than the number of the two or more congress member nodes. For example, when the number of the two or more congress member nodes is 10, the preset number may be one of 6, 7, 8, 9, and 10.

The preset number may ensure that such a phenomenon that the two candidate blocks generated satisfy the preset vote number condition and may ensure the number of the affirmative vote on the new block exceeds a half and reduce the number of malicious nodes, so that the security of the new block is higher. In addition, the other one of the two candidate blocks generated that does not satisfy the preset vote number condition is abandoned, so that the influence of the other one of the two candidate blocks generated that does not satisfy the condition on a next round of generation of new block can be prevented.

In some implementation modes, before the step 101, the block generation control method further includes step 104. At step 104: determining the current speaker node and the current deputy speaker node in the two or more congress member nodes based on a preset polling mechanism, a current moment, and a generation complete moment of a previous block of the new block in the blockchain.

It can be understood that the polling mechanism refers to inquiring each congress member node in order according to a certain time interval. By means of determining the current speaker node and the current deputy speaker node on the basis of the polling mechanism, the current moment, and the generation complete moment, each node may become the current speaker node and the current deputy speaker node in turn, which achieves periodic change of the current speaker node and the current deputy speaker node.

It should be noted that when the above step 104 is executed, the new block has been generated for the blockchain. That is, in the step 104, the generation complete moment of the previous block of the new block is reasonable. In other words, the step 104 is not executed before a new block is generated for the blockchain for the first time. Before the new block is generated for the first time, the current speaker node and the current deputy speaker node need to be designated. Before new blocks are generated for the second time and the following times, step 104 may be executed to determine a new current speaker node and current deputy speaker node.

In addition, in the step 104, the new block mentioned refers to the new block to be generated in the step 103.

Based on the step 104, in some implementation modes, after the step 101, the block generation control method further includes: when a used duration reaches a preset duration threshold, performing the step 104, the step 101, the step 102 and the step 103 in sequence; wherein the used duration is a duration between the generation complete moment and the current moment.

For example, at each time when a used duration reaches a preset duration threshold, returning to perform the step 104 and the subsequent steps, wherein the used duration is a duration between the generation complete moment and the current moment.

The used duration reaching the preset duration threshold may be understood as the used duration being greater than or equal to the preset duration threshold.

In the used duration, one round of determination of the current speaker node and the current deputy speaker node may be completed. At each time when the used duration reaches the preset duration threshold, step 104 is executed to re-determine a current speaker node and a current deputy speaker node, so as to re-generate candidate blocks and execute the steps of determining a new block and the like.

Based on the used duration and the preset duration threshold, in some implementation modes, each of the two or more congress member nodes has a sequence number, with sequence numbers of the two or more congress member nodes being continuous and starting from zero. The sequence number is an integer. The step 104 includes step 1041 and step 1042.

At step 1041: determining a deviation value based on the used duration and the preset duration threshold; and at step 1042: determining the current speaker node and the current deputy speaker node in the two or more congress member nodes based on the deviation value and the sequence numbers of the two or more congress member nodes.

By means of step 1041, the deviation value may be determined. By means of step 1042, the current speaker node and the current deputy speaker node may be determined according to a relation between the deviation value and the sequence number.

Based on the step 1041, in some implementation modes, the step 1041 includes: dividing the used duration by the preset duration threshold to obtain a quotient, and rounding down the quotient to obtain the deviation value.

Based on the step 1042, in some implementation modes, the step 1042 includes: determining a height of the new block; determining a sum of the height of the new block and the deviation value by the number of the two or more congress member nodes to obtain a first remainder; determining a sum of the height of the new block, the deviation value, and one by the number of the two or more congress member nodes to obtain a second remainder; and determining, from the two or more congress member nodes, a first node having the sequence number equal to the first remainder as the current speaker node, and determining, from the two or more congress member nodes, a second node having the sequence number equal to the second remainder as the current deputy speaker node.

It can be understood that the height of the block is an index or ID of the block in the blockchain, and the height of the block is incremented from 0. The height of the block is used to measure the distance between a certain block and the first block of the blockchain, which can indicate the position of a certain block in the blockchain.

In addition, in the step 1042, the new block mentioned refers to the new block to be generated in the step 103.

Based on the step 1041 and the step 1042, in the process of continuously generating new blocks, as the height increases, the first remainder and the second remainder correspondingly increase or decrease, so that alternation of the current speaker node and the current deputy speaker node can be achieved in turn from a certain node.

In an actual application scenario, the two or more congress member nodes are specifically as shown in Table 1 below.

TABLE 1

| Sequence number of | Name of congress member |
|---|---|
| congress member nodes | nodes |
| 0 | Node A |
| 1 | Node B |
| 2 | Node C |
| 3 | Node D |
| 4 | Node E |
| 5 | Node F |

Firstly, the height of the new block to be generated of the blockchain is determined, which is denoted as H.

Secondly, the preset duration threshold is denoted as T; the current moment is denoted as Tc; the generation complete time is denoted as To; therefore, the used duration is Tc−To; after the quotient is calculated on the basis of the formula of (Tc−To)/T, the deviation value P is then obtained by rounding down the quotient.

Thirdly, the sequence number of the current speaker node is set to be Nx; the sequence number of the current deputy speaker node is set to be Mx; the number of the congress member nodes in Table 1 above is denoted as N (in Table 1, N=6); Nx is calculated on the basis of a formula Nx=(H+P) % N; Mx is calculated on the basis of a formula Mx=(H+P+1)%, % being a division mod operator.

Fourthly, in Table 1, the node having the sequence number Nx is determined as the current speaker node, and the node having the sequence number Mx is determined as the current deputy speaker node.

Therefore, with the increase of blocks of the blockchain and the change in the used duration Tc−To of generation of a new block at each time and height H, each node in the two or more congress member nodes will be the current speaker node or the current deputy speaker node in turn to achieve periodic change of the current speaker node and the current deputy speaker node.

In this embodiment of the present application, when the current speaker node and the current deputy speaker node generate the two candidate blocks, the voting-related information when the previous block of the new block is generated may be stored in the two candidate blocks generated. The voting-related information may include one or more of voting nodes, the number of the affirmative vote, and other related information, which is not limited here.

Before each node votes on a certain candidate block, the generation node and generation time of the candidate block may be checked to determine whether there is any abnormality. The voting-related information stored in the candidate block may also be verified to determine whether there is any abnormality and whether there is an abnormality. A smart contract and transaction used in the generation of the candidate block may also be verified to determine whether there is an abnormality.

When there is at least one abnormality after the above verification, the candidate block will be abandoned. When there is no abnormality after the above verification, the corresponding node will continue to be triggered to vote on the candidate block.

In some implementation modes, the block generation control method further includes: when a target node exists in the two or more congress member nodes, the target node is determined as a non-congress member node of the blockchain, where the target node is a node that fails to generate a candidate block for a preset number of consecutive times when the node is the current speaker node. In other words, the target node is a node that has not generated a candidate block for the preset number of consecutive times during the period of becoming the current speaker node.

Based on the target node, in some implementation modes, after the target node is determined as a non-congress member node, the block generation control method further includes: the sequence numbers of the congress member nodes whose sequence numbers are behind that of the target node are adaptively adjusted so that all the current congress member nodes have consecutive sequence numbers starting from zero.

Specifically, as shown in Table 1, when the target node is node C, after node C is determined as the non-congress member node, node C is excluded from Table 1. The sequence number of node D is updated to be 2; the sequence number of node E is updated to be 3; and the sequence number of node F is updated to be 4.

It should be noted that determining the target node as a non-congress member node means canceling the identity authentication of a congress member node for the target node, that is, the target node is excluded from the two or more congress member nodes.

When a congress member node fails to generate one candidate block during the period of becoming the current speaker node for a preset number of consecutive times, the congress member node may be malicious and not generate candidate blocks, or it may be unable to generate candidate blocks due to unexpected factors (such as network disconnection). Therefore, at this time, the target node is determined as a non-congress member node to avoid a malicious node or to avoid that an unexpected node becomes the current speaker node or the current deputy speaker node, so as to prevent the waste of time and improve the speed of block generation.

In addition, a joining request may be received on the basis of a congress management smart contract deployed on the blockchain, and whether the node that sends the joining request is allowed to become a congress member node is determined on the basis of the joining request. In this way, the number of congress member nodes may be increased.

It should be noted that the blockchain may be a blockchain applied to energy storage transactions, and specifically may be used to record energy storage data generated (which may include one or more of account data, energy transmission data, etc.) in the energy storage transactions. The new block generated by the block generation control method may be used to store the energy storage data. The blockchain may also be applied to e-commerce transactions or other types of transactions. The new block may also be used to record/generate relevant data, which is not limited here.

### Embodiment II

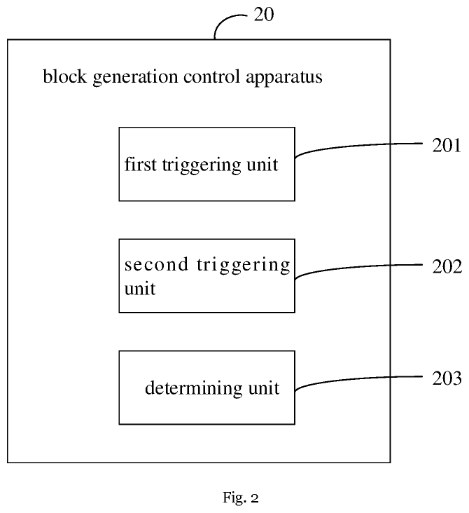

The present application provides a block generation control apparatus applied to a blockchain. The blockchain includes two or more congress member nodes. As shown in FIG. 2, the block generation control apparatus 20 includes a first triggering unit 210, a second triggering unit 202, and a determining unit 203.

The first triggering unit 201 is configured to trigger a current speaker node and a current deputy speaker node in the two or more congress member nodes to start to generate two candidate blocks, respectively.

The second triggering unit 202 is configured to trigger all or part of nodes in the two or more congress member nodes to vote on the two candidate blocks generated, to generate a voting result.

The determining unit 203 is configured to determine, based on the voting result, one candidate block of the two candidate blocks that satisfies a preset vote number condition as a new block of the blockchain.

In some implementation modes, the second triggering unit 202 is specifically configured to: trigger each node in the two or more congress member nodes to vote an affirmative vote for the two candidate blocks generated. Each node in the two or more congress member nodes only votes the affirmative vote for one of the two candidate blocks generated. In other words, one node may vote an affirmative vote for one candidate block at most. The preset vote number condition include: a number of the affirmative vote obtained in the voting result is greater than a preset number.

Based on the above-mentioned preset vote number condition, in some implementation modes, the preset number is greater than half of the number of the two or more congress member nodes. The determining unit 203 is specifically configured to: based on the voting result, determine one of the two candidate blocks generated that satisfies the preset vote number condition as a new block of the blockchain, and abandoning the other one of the two candidate blocks generated that does not satisfy the preset vote number condition.

In some implementation modes, the first triggering unit 201 is also configured to: determine the current speaker node and the current deputy speaker node in the two or more congress member nodes based on a preset polling mechanism, a current moment, and a generation complete moment of a previous block of the new block in the blockchain.

In some implementation modes, the first triggering unit 201 is also configured to: at each time when a used duration reaches a preset duration threshold, return to perform the step of determining the current speaker node and the current deputy speaker node in the two or more congress member nodes and the subsequent steps, wherein the used duration is a duration between the generation complete moment and the current moment.

Based on the used duration and the preset duration threshold, in some implementation modes, each of the two or more congress member nodes has a sequence number, with sequence numbers of the two or more congress member nodes being continuous and starting from zero. The sequence number is an integer. The first triggering unit 201 is specifically configured to: determine a deviation value based on the used duration and the preset duration threshold; determine the current speaker node and the current deputy speaker node based on the deviation value and the sequence numbers of the two or more congress member nodes.

In some implementation modes, the first triggering unit 201 is specifically configured to: divide the used duration by the preset duration threshold to obtain a quotient, and rounding down the quotient to obtain the deviation value; determine a height of the new block; divide a sum of the height of the new block and the deviation value by a number of the two or more congress member nodes to obtain a first remainder; divide a sum of the height of the new block, the deviation value, and one by the number of the two or more congress member nodes to obtain a second remainder; and determine, from the two or more congress member nodes, a first node having the sequence number equal to the first remainder as the current speaker node, and determine, from the two or more congress member nodes, a second node having the sequence number equal to the second remainder as the current deputy speaker node.

In some implementation modes, the determining unit 203 is also configured to: when a target node exists in the two or more congress member nodes, determine the target node as a non-congress member node of the blockchain, where the target node is a node that fails to generate a candidate block for a preset number of consecutive times when the node is the current speaker node.

It should be noted that the block generation control apparatus provided by the present application can achieve the same step functions as those in the above-mentioned block generation control method and has the same technical effects. Contents in the block generation control method that are not repeatedly recorded in the block generation control apparatuses shall be deemed as being clearly recorded in the specification.

It can be seen from the above that the technical solutions include triggering a current speaker node and a current deputy speaker node in the two or more congress member nodes to start to generate two candidate blocks, respectively; triggering all or part of nodes in the two or more congress member nodes to vote on the two candidate blocks generated, to generate a voting result; and determining, based on the voting result, one candidate block of the two candidate blocks generated that satisfies a preset vote number condition as a new block of the blockchain.

Based on the technical solutions of the present application, a situation that a malicious node generates a block can be avoided by means of voting (when the congress member nodes do not include more than half of malicious nodes, it can be ensured that blocks are normally generated). Votes can be taken on the two candidate blocks generated by the current speaker node and the current deputy speaker node, and the competitiveness of the generated blocks is ensured by means of determining the new block of the blockchain, so that the fault tolerance rate, speed and security of block generation are improved.

### Embodiment III

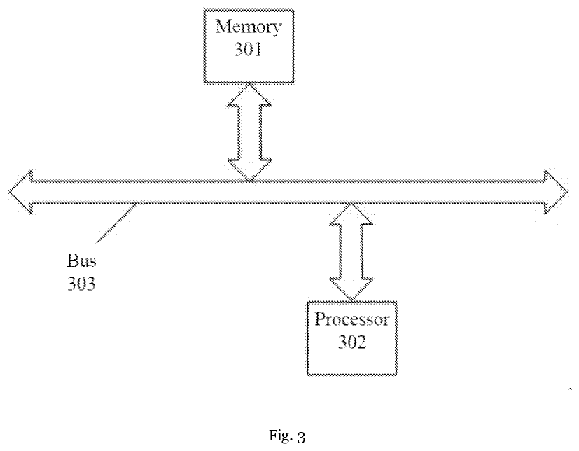

The present application further provides another block generation control apparatus applied to a blockchain. The above-mentioned blockchain includes two or more congress member nodes. As shown in FIG. 3, the block generation control apparatus in this embodiment of the present application includes a non-transitory memory 301, a processor 302, and a computer program which is stored in the memory 301 and is operable on the processor 302. The memory 301 is configured to store software programs and modules. The processor 302 operates the software programs and modules stored in the memory 301 to execute various function applications and data processing. The memory 301 and the processor 302 are connected through a bus 303.

Specifically, the processor 302 achieves the step 101, the step 102, and the step 103 by means of operating the computer program stored in the memory 301.

At step 101: triggering a current speaker node and a current deputy speaker node in the two or more congress member nodes to start to generate two candidate blocks, respectively.

At step 102: triggering all or part of nodes in the two or more congress member nodes to vote on the two candidate blocks generated, to generate a voting result.

At step 103: determining, based on the voting result, one candidate block of the two candidate blocks generated that satisfies a preset vote number condition as a new block of the blockchain.

If the above is a first possible implementation mode, based on the first possible implementation mode, in a second possible implementation mode, the step 102 includes: triggering each node in the two or more congress member nodes to vote an affirmative vote for the two candidate blocks generated. Each node in the two or more congress member nodes only votes the affirmative vote for one of the two candidate blocks generated. In other words, one node may vote an affirmative vote for one candidate block at most. The preset vote number condition include: a number of the affirmative vote obtained in the voting result is greater than a preset number.

Based on the second possible implementation mode, in a third possible implementation mode, the preset number is greater than half of the number of the two or more congress member nodes. Step 103 further includes: abandoning the other one of the two candidate blocks generated that does not satisfy the preset vote number condition.

Based on the first or second or third possible implementation mode, in a fourth possible implementation mode, before the step 101, the block generation control method further includes step 104. At step 104: determining the current speaker node and the current deputy speaker node in the two or more congress member nodes based on a preset polling mechanism, a current moment, and a generation complete moment of a previous block of the new block in the blockchain.

Based on the fourth possible implementation mode, in a fifth possible implementation mode, after the step 101, the block generation control method further includes: when a used duration reaches a preset duration threshold, performing the step 104 and the subsequent steps, wherein the used duration is a duration between the generation complete moment and the current moment.

Based on the fifth possible implementation mode, in a sixth possible implementation mode, each of the two or more congress member nodes has a sequence number, with sequence numbers of the two or more congress member nodes being continuous and starting from zero. The sequence number is an integer. The step 104 includes step 1041 and step 1042.

At step 1041: determining a deviation value based on the used duration and the preset duration threshold; and at step 1042: determining the current speaker node and the current deputy speaker node in the two or more congress member nodes based on the deviation value and the sequence number of the two or more congress member nodes.

Based on the sixth possible implementation mode, in a seventh possible implementation mode, the step 1041 includes: dividing the used duration by the preset duration threshold to obtain a quotient, and rounding down the quotient to obtain the deviation value.

The step 1042 includes: determining a height of the new block; determining a sum of the height of the new block and the deviation value by the number of the two or more congress member nodes to obtain a first remainder; determining a sum of the height of the new block, the deviation value, and one by the number of the two or more congress member nodes to obtain a second remainder; and determining, from the two or more congress member nodes, a first node having the sequence number equal to the first remainder as the current speaker node, and determining, from the two or more congress member nodes, a second node having the sequence number equal to the second remainder as the current deputy speaker node.

Based on the first or second or third possible implementation mode, in an eighth possible implementation mode, the block generation control method further includes: when a target node exists in the two or more congress member nodes, the target node is determined as a non-congress member node of the blockchain, where the target node is a node that fails to generate a candidate block for a preset number of consecutive times when the node is the current speaker node.

It should be noted that the block generation control apparatus provided by the present application can achieve the same step functions as those in the above-mentioned block generation control method and has the same technical effects. Contents in the block generation control method that are not repeatedly recorded in the block generation control apparatuses shall be deemed as being clearly recorded in the specification.

It can be seen from the above that the technical solutions include triggering a current speaker node and a current deputy speaker node in the two or more congress member nodes to start to generate two candidate blocks, respectively; triggering all or part of nodes in the two or more congress member nodes to vote on the two candidate blocks generated, to generate a voting result; and determining, based on the voting result, one candidate block of the two candidate blocks generated that satisfies a preset vote number condition as a new block of the blockchain.

Based on the technical solutions of the present application, a situation that a malicious node generates a block can be avoided by means of voting (when the congress member nodes do not include more than half of malicious nodes, it can be ensured that blocks are normally generated). Votes can be taken on the two candidate blocks generated by the current speaker node and the current deputy speaker node, and the competitiveness of the generated blocks is ensured by means of determining the new block of the blockchain, so that the fault tolerance rate, speed and security of block generation are improved.

### Embodiment IV

The present application also provides a non-transitory computer-readable storage medium. A computer program is stored on the non-transitory computer-readable storage medium. The computer program, when executed, may achieve the steps provided in Embodiment I, which will not be repeated here.

It should be noted that the computer program can achieve the same step functions as those in the above-mentioned block generation control method and has the same technical effects. Contents in the block generation control method that are not repeatedly recorded in the embodiment IV shall be deemed as being clearly recorded in the specification.

Specifically, the computer program includes a computer program code. The above-mentioned computer program code may be one of a source code form, an object code form, an executable file or some intermediate forms, which is not limited here. The non-transitory computer-readable storage medium may be any entity or apparatus, recording medium, U disk, mobile hard disk, magnetic disk, optical disk, computer memory, read-only memory (ROM), random access memory (RAM), electric carrier signal, telecommunication signal and a software distribution medium that may carry the above-mentioned computer program code, which is not limited here. It should be noted that the content contained in the non-transitory computer-readable storage medium may be appropriately increased or decreased according to the requirements of legislation and patent practice in the jurisdiction.

It can be seen from the above that the technical solutions include triggering a current speaker node and a current deputy speaker node in the two or more congress member nodes to start to generate two candidate blocks, respectively; triggering all or part of nodes in the two or more congress member nodes to vote on the two candidate blocks generated, to generate a voting result; and determining, based on the voting result, one candidate block of the two candidate blocks generated that satisfies a preset vote number condition as a new block of the blockchain.

Based on the technical solutions of the present application, a situation that a malicious node generates a block can be avoided by means of voting (when the congress member nodes do not include more than half of malicious nodes, it can be ensured that blocks are normally generated). Votes can be taken on the two candidate blocks generated by the current speaker node and the current deputy speaker node, and the competitiveness of the generated blocks is ensured by means of determining the new block of the blockchain, so that the fault tolerance rate, speed and security of block generation are improved.

The foregoing description of the disclosed embodiments enables those skilled in the art to implement or use the present application. Various modifications to these embodiments will be apparent to those skilled in the art, and the general principles defined herein can be implemented in other embodiments without departing from the spirit or scope of the present application. Therefore, the present application will not be limited to these embodiments shown in this text, but should conform to the widest scope consistent with the principles and novel features disclosed herein.

Those skilled in the art can clearly understand that for the convenience and simplicity of description, only the division of the above-mentioned functional units and modules is used as an example. In actual practice, the above functions can be assigned to different functional units and modules for completion according to needs, that is, the internal structure of the above-mentioned apparatus can be divided into different functional units or modules to complete all or part of the functions described above. Each functional module in the embodiments may be integrated into one processing unit, or each unit may physically exist alone, or two or more units may be integrated into one unit. The above integrated units may be implemented in the form of hardware or software functional units. In addition, specific names of all the functional units and modules are only for the convenience of distinguishing each other, and are not used to limit the protection scope of the present disclosure. For the specific working process of the units and modules in the foregoing system, reference may be made to the corresponding process in the foregoing method embodiment, which is not repeated here.

It should be noted that, the methods and detailed examples provided in the foregoing embodiments may be combined into the apparatuses and devices provided in the embodiments and refer to each other, which will not be repeated here.

Those of ordinary skill in the art may realize that the units and algorithm steps of all the examples described in combination with the embodiments disclosed herein can be implemented by electronic hardware or a combination of computer software and electronic hardware. Whether these functions are executed by hardware or software depends on the specific application and design constraints of the technical solutions. Skilled artisans may implement the described functionality using different methods for each particular application, but such implementations should not be considered beyond the scope of this application.

In the embodiments provided by the present application, it should be understood that the disclosed apparatus/terminal device and method may be implemented in other ways. For example, the apparatus/device embodiments described above are merely illustrative. For example, the division of the module or unit is only a logical function division. In actual implementation, there may be another division manner. For example, a plurality of units or components may be combined or integrated into another system, or some features may be ignored or not executed.

The above-mentioned embodiments are only used to illustrate the technical solutions of the present application, not intended to limit them. Although the present application has been described in detail with reference to the foregoing embodiments, those of ordinary skill in the art should understand that they still can modify the technical solutions recorded in all the foregoing embodiments, or replace partial technical features by equivalences. These modifications or replacements do not cause the essences of the corresponding technical solutions to depart from the spirit and scope of the technical solutions of all the embodiments of the present application, and shall fall within the protection scope of the present application.

What is claimed is:

1. A block generation control method applied to a blockchain, the blockchain comprising two or more congress member nodes; wherein the method comprises:
a first triggering step: triggering a current speaker node and a current deputy speaker node in the two or more congress member nodes to generate two candidate blocks, respectively;
a second triggering step: triggering all or part of nodes in the two or more congress member nodes to vote on the two candidate blocks generated, to generate a voting result; and
a determining step: determining, based on the voting result, one candidate block of the two candidate blocks that satisfies a preset vote number condition as a new block of the blockchain.

2. The method according to claim 1, wherein before the first triggering step, the method further comprises:
a voting step: determining the current speaker node and the current deputy speaker node based on a preset polling mechanism, a current moment, and a generation complete moment of a previous block before the new block in the blockchain.

3. The method according to claim 2, wherein after the first triggering step, the method further comprises:
when a used duration reaches a preset duration threshold, performing the voting step, the first triggering step, the second triggering step and the determining step in sequence, wherein the used duration is a duration between the generation complete moment and the current moment.

4. The method according to claim 3, wherein each of the two or more congress member nodes has a sequence number, sequence numbers of the two or more congress member nodes being continuous and starting from zero, and the sequence number is an integer; and
the voting step comprises:
a first voting step: determining a deviation value based on the used duration and the preset duration threshold; and
a second voting step: determining the current speaker node and the current deputy speaker node based on the deviation value and the sequence numbers of the two or more congress member nodes.

5. The method according to claim 4, wherein:
the first voting step comprises:
dividing the used duration by the preset duration threshold to obtain a quotient, and rounding down the quotient to obtain the deviation value; and
the second voting step comprises:
determining a height of the new block;
dividing a sum of the height of the new block and the deviation value by a number of the two or more congress member nodes to obtain a first remainder;
dividing a sum of the height of the new block, the deviation value, and one by the number of the two or more congress member nodes to obtain a second remainder; and
determining, from the two or more congress member nodes, a first node having the sequence number equal to the first remainder as the current speaker node, and determining, from the two or more congress member nodes, a second node having the sequence number equal to the second remainder as the current deputy speaker node.

6. The method according to claim 1, further comprising:
when a target node exists in the two or more congress member nodes, determining the target node as a non-congress member node of the blockchain, wherein the target node is a node that fails to generate a candidate block for a preset number of consecutive times when the node is the current speaker node.

7. The method according to claim 1, wherein the second triggering step comprises:
triggering each node in the two or more congress member nodes to vote an affirmative vote for the two candidate blocks generated, wherein each node in the two or more congress member nodes only votes the affirmative vote for one of the two candidate blocks generated; and
the preset vote number condition comprises: an obtained number of the affirmative vote in the voting result is greater than a preset number.

8. The method according to claim 7, wherein before the first triggering step, the method further comprises:
a voting step: determining the current speaker node and the current deputy speaker node based on a preset polling mechanism, a current moment, and a generation complete moment of a previous block of the new block in the blockchain.

9. The method according to claim 8, wherein after the first triggering step, the method further comprises:
when a used duration reaches a preset duration threshold, performing the voting step, the first triggering step, the second triggering step and the determining step in sequence, wherein the used duration is a duration between the generation complete moment and the current moment.

10. The method according to claim 9, wherein each of the two or more congress member nodes has a sequence number, sequence numbers of the two or more congress member nodes being continuous and starting from zero, and the sequence number is an integer; and
the voting step comprises:
a first voting step: determining a deviation value based on the used duration and the preset duration threshold; and
a second voting step: determining the current speaker node and the current deputy speaker node based on the deviation value and the sequence numbers of the two or more congress member nodes.

11. The method according to claim 10, wherein:
the first voting step comprises:
dividing the used duration by the preset duration threshold to obtain a quotient, and rounding down the quotient to obtain the deviation value; and
the second voting step comprises:
determining a height of the new block;
dividing a sum of the height of the new block and the deviation value by a number of the two or more congress member nodes to obtain a first remainder;
dividing a sum of the height of the new block, the deviation value, and one by the number of the two or more congress member nodes to obtain a second remainder; and
determining, from the two or more congress member nodes, a first node having the sequence number equal to the first remainder as the current speaker node, and determining, from the two or more congress member nodes, a second node having the sequence number equal to the second remainder as the current deputy speaker node.

12. The method according to claim 7, further comprising:
when a target node exists in the two or more congress member nodes, determining the target node as a non-congress member node of the blockchain, wherein the target node is a node that fails to generate a candidate block for a preset number of consecutive times when the node is the current speaker node.

13. The method according to claim 7, wherein the preset number is greater than half of a number of the two or more congress member nodes;
the determining step further comprises:
abandoning the other one of the two candidate blocks that does not satisfy the preset vote number condition.

14. The method according to claim 13, wherein before the first triggering step, the method further comprises:
a voting step: determining the current speaker node and the current deputy speaker node based on a preset polling mechanism, a current moment, and a generation complete moment of a previous block of the new block in the blockchain.

15. The method according to claim 14, wherein after the first triggering step, the method further comprises:
when a used duration reaches a preset duration threshold, performing the voting step, the first triggering step, the second triggering step and the determining step in sequence, wherein the used duration is a duration between the generation complete moment and the current moment.

16. The method according to claim 15, wherein each of the two or more congress member nodes has a sequence number, sequence numbers of the two or more congress member nodes being continuous and starting from zero, wherein the sequence number is an integer; and
the voting step comprises:
a first voting step: determining a deviation value based on the used duration and the preset duration threshold; and
a second voting step: determining the current speaker node and the current deputy speaker node based on the deviation value and the sequence numbers of the two or more congress member nodes.

17. The method according to claim 16, wherein:
the first voting step comprises:
dividing the used duration by the preset duration threshold to obtain a quotient, and rounding down the quotient to obtain the deviation value; and
the second voting step comprises:
determining a height of the new block;
dividing a sum of the height of the new block and the deviation value by the number of the two or more congress member nodes to obtain a first remainder;
dividing a sum of the height of the new block, the deviation value, and one by the number of the two or more congress member nodes to obtain a second remainder; and
determining, from the two or more congress member nodes, a first node having the sequence number equal to the first remainder as the current speaker node, and determining, from the two or more congress member nodes, a second node having the sequence number equal to the second remainder as the current deputy speaker node.

18. The method according to claim 13, further comprising:
when a target node exists in the two or more congress member nodes, determining the target node as a non-congress member node of the blockchain, wherein the target node is a node that fails to generate a candidate block for a preset number of consecutive times when the node is the current speaker node.

19. A block generation control apparatus applied to a blockchain, the blockchain comprising two or more congress member nodes, the apparatus comprising a non-transitory memory and a processor, the memory storing a computer program, and the processor, when executing the computer program, performs:
a first triggering step: triggering a current speaker node and a current deputy speaker node in the two or more congress member nodes to generate two candidate blocks, respectively;
a second triggering step: triggering all or part of nodes in the two or more congress member nodes to vote on the two candidate blocks generated, to generate a voting result; and
a determining step: determining, based on the voting result, one candidate block of the two candidate blocks that satisfies a preset vote number condition as a new block of the blockchain.

20. A non-transitory computer-readable storage medium, the non-transitory computer-readable storage medium storing a computer program, wherein the computer program, when executed by a processor, cause the processor to perform:
a first triggering step: triggering a current speaker node and a current deputy speaker node in two or more congress member nodes of a blockchain to generate two candidate blocks, respectively;
a second triggering step: triggering all or part of nodes in the two or more congress member nodes to vote on the two candidate blocks generated, to generate a voting result; and
a determining step: determining, based on the voting result, one candidate block of the two candidate blocks that satisfies a preset vote number condition as a new block of the blockchain.
